(19) United States
(12) Patent Application Publication
(10) Pub. No.: US 2008/0136616 A1
(43) Pub. Date: Jun. 12, 2008

(54) THROTTLE FOOT POSITION INDICATOR

(76) Inventor: NEIL A. PANCOAST, PHILADELPHIA, PA (US)

Correspondence Address: MARK J. ROSEN P.C., 418 BARCLAY ROAD, BRYN MAWR, PA, 19010, US

(21) Appl. No.: 11/952,573

(22) Filed: Dec. 7, 2007

Related U.S. Application Data
(60) Provisional application No. 60/869,050, filed on Dec. 7, 2006.

(51) Int. Cl. B60Q 11/00

(52) U.S. Cl. 340/458

(57) ABSTRACT

The invention provides a novel indicator system for automobiles which displays three different colored lamps corresponding to different positions of a driver's throttle foot: On the throttle, on the brake, or off both the throttle and the brake. Further, the indicator system is capable of indicating whether both the brake and accelerator pedals are being depressed at the same time.

### FIELD OF THE INVENTION

The invention provides a novel indicator system for automobiles which displays three different colored lamps corresponding to different positions of a driver's throttle foot: On the throttle, on the brake, or off both the throttle and the brake. Further, the indicator system is capable of indicating whether both the brake and accelerator pedals are being depressed at the same time.

### BACKGROUND OF THE INVENTION

Modern automobiles provide a third brake light to assist in alerting following automobiles that a driver has depressed the brake pedal. However, the current brake light system in use today indicates only when a lead driver's foot is on or off the brake pedal. There have been several attempts to provide an improved indicator system that provides more information than only the brake lights used today, but none have achieved the efficacy of the present invention. The throttle foot position indicator described herein provides additional information for following automobiles, indicates the position of a driver's throttle foot at all times, and provides following drivers more time to react to changes in the lead automobile's speed.

U.S. Pat. No. 3,601,796 discloses an accelerator release signal light delay actuator which provides a delayed signal when a driver releases the accelerator pedal, such delay intended to account for those possibilities where no warning is necessary, e.g., when the driver may not be preparing to apply the brake pedal.

U.S. Pat. No. 4,149,141 discloses a vehicle light assembly comprising a bewildering array of rotatably mounted pluralities of bulbs for indicating certain states of acceleration and deceleration.

U.S. Pat. No. 4,224,598 discloses a vehicle reaction signal comprising a stop light and a backup light. The stop light is lighted upon application of the brake pedal, while the backup light is lighted upon either releasing the brake pedal or releasing the accelerator pedal.

U.S. Pat. No. 5,023,599 discloses a throttle position sensor advanced brake light device designed to turn on an otherwise ordinary brake light upon a sudden release of the accelerator pedal.

U.S. Pat. No. 5,491,466 discloses a brake light system in which the brake light is lighted not only when the brake pedal is applied, but, through use of a sensor coupled to the throttle, the brake light also lights when the accelerator pedal has remained in an idle, or released, position for a predesignated duration.

U.S. Pat. No. 4,034,338 discloses a signal light system coupled with both brake system and throttle system, having a circuit wherein the lighting of one of the bulbs prevents lighting of other bulbs.

U.S. Pat. No. 4,470,036 discloses an automobile signal system employing three colored lights to indicate a driver's foot position with respect to the brake and accelerator pedals. However, the system is designed so that the red brake signal can not operate if the accelerator pedal is also being depressed, thus the device is incapable of indicating brake pedal usage in the event a driver actually has one foot on the brake pedal and one foot, even lightly, on the accelerator pedal. In defeating the brake light, a following driver may well be led falsely to believe that the leading driver is not decelerating, thereby unnecessarily risking collision.

All references cited above are hereby incorporated by reference. While many of the above light systems above provide teaching of the means to equip automobiles with lamps activated by sensors configured to detect accelerator and brake pedal action, and means for providing the necessary circuitry therefor, none are capable of indicating the position of a driver's foot at all times, including the ability to indicate whether both the accelerator and brake pedals are being depressed at the same time. The art is in need of an improved throttle foot position indicator system which displays the position of the drivers foot at all times and in all possible positions.

### SUMMARY OF THE INVENTION

The present invention is a novel throttle foot position indicator system, suitable to replace the currently common third brake light indicator mounted in the center of the rear window or rear panel of a vehicle, although alternative placements are envisioned as well. The invention provides a driver in a following vehicle precise information as to the placement of the lead driver's feet on the operating throttle and brake pedals of the vehicle. An additional feature of the invention is that it also indicates if the lead driver is using both feet for throttle and brake control, thereby indicating an inexperienced and potentially dangerous driver. The art is in need of the additional safety provided by the device of the invention; it provides drivers of following vehicles more time to react to the braking and accelerating patterns of vehicles ahead. This added time is expected to reduce collisions, particularly rear end collisions, and thereby avoid injuries as well.

The present invention relies on a plurality of lamps mounted at the rear of the vehicle to indicate where the driver's throttle foot is at all times, whether it be on the accelerator pedal, on the brake pedal, or off both the accelerator and brake pedals. The invention may also indicate the degree to which the accelerator pedal is depressed, as well as whether the driver is using two feet on both the brake and accelerator pedals at the same time, indicating that the driver may be inexperienced.

Thus, in one aspect, the invention comprises a throttle foot position indicator system for an automobile comprising a throttle lamp operably coupled to a throttle position sensor, an idle lamp operably coupled to the throttle position sensor and a brake position sensor, and a brake lamp operably coupled to the brake position sensor, wherein the throttle lamp is illuminated when an accelerator pedal is depressed; the idle lamp is illuminated when neither the accelerator pedal is depressed nor a brake pedal is depressed; and the brake lamp is illuminated when the brake pedal is depressed.

In another aspect, the throttle lamp blinks when the accelerator pedal is depressed more than about halfway through its range of travel. In another aspect, the throttle lamp blinks slowly when the accelerator pedal is depressed in a range from about halfway to about three quarters of the way through its range of travel, and blinks rapidly when the accelerator pedal is depressed further than about three quarters of the way through its range of travel.

In another aspect, the throttle lamp comprises a plurality of lamps, wherein a first throttle lamp illuminates when the accelerator pedal is depressed less than about halfway through its range of travel, a second throttle lamp illuminates when the accelerator pedal is depressed in a range from about halfway to about three quarters of the way through its range of travel, and a third throttle lamp illuminates when the accelerator pedal is depressed more than about three quarters of the way through its range of travel. In another aspect, the idle lamp and the brake lamp each comprise a plurality of lamps.

In another aspect of the present invention, the throttle lamp is blue, the idle lamp is amber, and the brake lamp is red.

These and additional features of the invention are exemplified and further described in the Detailed Description of the Invention below.

### BRIEF DESCRIPTION OF THE DRAWINGS

FIG. 1 is a diagram of one embodiment of the invention, employing blue, amber, and red light lamps. FIG. 1 illustrates the status of the lamps under different foot positions.

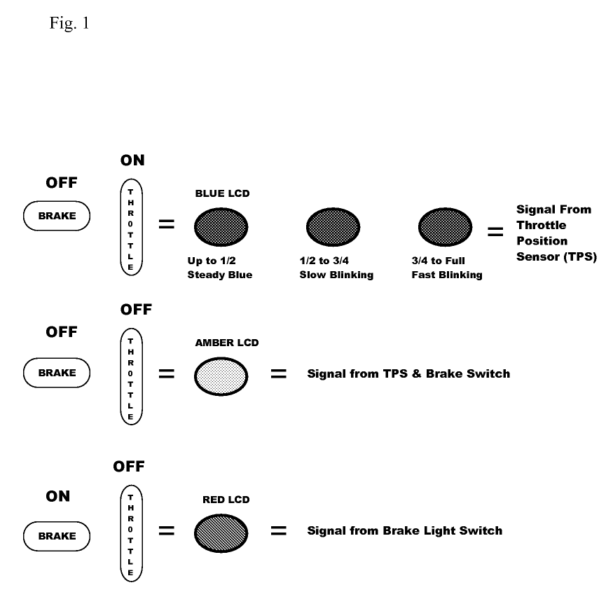

FIG. 2 is a schematic view of one embodiment of the invention, having a generally rectangular aspect with three colored lamps mounted therein, suitable for replacing the common third brake light of today's automobiles.

### DETAILED DESCRIPTION OF THE INVENTION

As described above in the Summary of the Invention, the device of the invention provides a first colored lamp, the throttle lamp, activated by a Throttle Position Sensor (TPS), which detects when the accelerator pedal is depressed. The throttle lamp actively lights when the accelerator pedal is depressed. A second colored lamp, the idle lamp, is activated by both the TPS and a Brake Position Sensor (BPS), which detects when the brake pedal is depressed. The idle lamp actively lights when the TPS indicates that the accelerator pedal is not being depressed, and the brake pedal is also not being depressed. A third colored lamp, the brake lamp, is activated by the BPS alone, and actively lights when the brake pedal is being depressed, i.e., when the braking system is activated.

The combination of the three colored lamps indicates the state of both the throttle and brake pedals. If the accelerator pedal alone is being depressed, the throttle lamp lights, while the idle lamp and the brake lamp do not light. If the brake pedal alone is being depressed, only the brake lamp lights, while the throttle and idle lamps do not light. If neither pedal is being depressed, the idle lamp lights, while the throttle and brake lamps do not light. Additionally, if both the throttle and brake pedals are depressed, such as when a driver has one feet on the accelerator pedal and one foot on the brake, or even one foot spanning both pedals, both the throttle and brake lamps lights, while the idle lamp remains unlit.

In another embodiment of the invention, the throttle lamp lights in two different states: steadily lit, or blinking. Each state corresponds to the degree to which the accelerator pedal is being depressed. When the accelerator is depressed in the early portion of its full travel, up to about half its range, the throttle lamp lights steadily and solid. When the accelerator is depressed more than about halfway, the throttle lamp blinks. In this embodiment, the indicator system provides additional information as to how far the driver is depressing the accelerator pedal. The point at which the change of state from steadily lit to blinking occurs may be adjusted as desired, from about one quarter to about three quarters of the range of the accelerator pedal. In a preferred embodiment, the change of state occurs at about halfway through the accelerator pedal's range.

In another embodiment, the throttle lamp may light in three different states. When the accelerator is depressed up to about half of its range, but less than about three quarters of its range, the throttle lamp blinks slowly. When the accelerator pedal is depressed more than three quarters of its range, the throttle lamp blinks rapidly. The rate of slow blinking may range from about once to about three times per second; rapid blinking may range from about three times per second to about eight times per second or more, so long as the rate of rapid blinking is noticeably greater than the rate of slow blinking. This embodiment provides further additional information to following drivers as to the degree of acceleration being employed by the driver of the leading car equipped with a device of the invention.

In another embodiment, the rate of blinking may progress smoothly from slow to rapid with increasing depression of the accelerator pedal.

In another embodiment, the throttle lamp itself comprises a plurality of lamps of the same or different color, which progressively indicate the extent of depression of the accelerator pedal. For example, in an embodiment in which the throttle lamp comprises a set of three colored lamps, the first throttle lamp lights upon initial accelerator pedal depression up to about halfway in its range. As depression increases over halfway, the second throttle lamp lights, and as depression increases over about three quarters of the range, the third throttle lamp lights. The idle and brake lamps as described above are also present in this aspect, and fulfill their function as described above, thus in this embodiment, there are five colored lamps. The throttle lamp may comprise a set of more than three lamps as well.

In some embodiments, a plurality of idle lamps and brake lamps may be used in accordance with the invention, such as when a strip of many lamps is desired. However, unlike a plurality of throttle lamps, which may progressively light as the accelerator pedal is depressed to increasing degrees, a plurality of idle lamps and/or brake lamps operate in unison such that all idle lamps light under the condition where no pedals are being depressed, and all brake lamps light under the condition where the brake light is being depressed. For example, such an embodiment may comprise three lamps of each of the throttle, pedals-off, and brake lamps, for a total of nine lamps, which may be in a linear (or other desirable) pattern laterally spread across the device.

As with the previous embodiment of the invention, the point at which the state changes from one to each additional throttle lamp may be varied consistent with the desired level of depression of the accelerator pedal to be indicated.

The lamps of the invention may employ traditional incandescent bulbs, fluorescent bulbs, LCDs, LEDs, and other lighting devices known in the art. Preferably, the lamps employ LEDs. Preferably, the lamps used in the invention are of automotive-grade quality, with similar intensity and other physical characteristics as those used in current brake lights. The throttle lamps, in embodiments in which they blink, are any of a variety known in the art, such as those used for turn signaling, which blink at a desired rate. Those of skill in the art are also familiar with lamps having two different rates of blinking, or smoothly increasing rates of blinking, controlled by appropriate circuitry, useful for those embodiments in which two rates of blinking are desired for the throttle lamp. Further, the lamps of the invention are housed in a housing of similar construction as those used in current third brake lights.

The colors of the lamps are chosen to promote clearly distinguishing between the lamps. Blue, amber, red, yellow, green, and a variety of colors are suitable for use in the invention. Preferably green is avoided because of its association with indicating freedom to proceed, such as in traffic lights. In one embodiment of a three lamp system of the invention, lamps of blue, amber, and red are used for the throttle, idle, and brake lamps, respectively. Preferably, the brake lamp is red, consistent with traditional use of red in other brake lamps. Preferably, the throttle lamp is blue and the idle lamp is amber.

The BPS, a brake position sensor, may be any of a variety of such sensors known in the art, such as those used to light ordinary brake lights and third brake lights. Such sensor may be directly coupled to the brake pedal itself, or anywhere else in the braking system provided that the sensor is capable of detecting that the brakes are being applied. The brake lamp of the invention is energized in essentially the same manner as the third brake light in modern automobiles, that is, the brake lamp is operably connected to the circuitry of the automobile such that in addition to the regular brake lights lighting upon depression of the brake pedal, the brake lamp of the invention is energized at the same time.

The TPS, a throttle position sensor, may be any of a variety of such sensors known in the art, such as those exemplified in the Background of the Invention above, all of which are incorporated herein by reference. The TPS may be operatively associated with the engine intake system, or alternatively with the accelerator pedal itself, or with any part of the throttle system provided that the TPS is capable of detecting that the accelerator pedal is being depressed. The TPS is capable of energizing the throttle lamp when the accelerator pedal is depressed, and is also capable of distinguishing the levels of depression of the accelerator pedal. The TPS and throttle lamp are operably connected such that the throttle lamp's different states of lighting are energized by the TPS-throttle lamp circuitry (i.e., depending on the embodiment of the invention: either solid vs. blinking states, or progressive lighting of a plurality of lamps).

By “accelerator pedal” it is meant any means of operating the automobile in an accelerating state, such as an actual accelerator floor pedal, or a steering column stalk of a cruise-controlled automobile, or the like, wherein acceleration may be caused without applying pressure with one's foot. Likewise, by “brake pedal” it is meant any means of applying braking force, including a traditional floor-mounted brake pedal, as well as devices capable of applying braking force by manual operation of the driver, without applying pressure with one's foot to a floor mounted brake pedal. The invention is further exemplified by the following Example.

### EXAMPLES

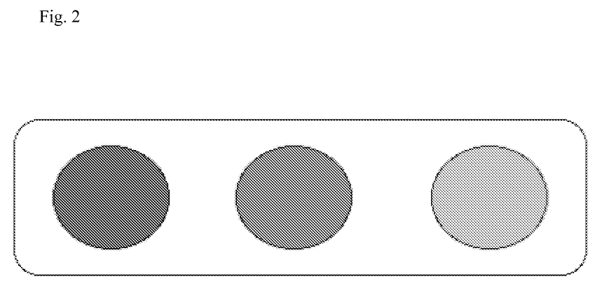

In this example, three automotive grade LED lamps are mounted in a similar housing and position such as that in which modern automobiles currently place a third brake light, or strip of lights. FIG. 2 provides an illustration of such an arrangement. The three bulbs are three different colors corresponding to and indicating the three possible positions of the throttle foot. The throttle lamp is a single blue lamp; the idle lamp is amber; and the brake lamp is red. With reference to FIG. 2, the lamp on the left is the blue throttle lamp, the center lamp is the red brake lamp, and the lamp on the right is the amber idle lamp.

The throttle foot position indicator in operation proceeds as follows. When the accelerator pedal is depressed, the throttle lamp lights a steady blue. The idle and brake lamps, amber and red, respectively, are unlit. As the accelerator is depressed further and reaches about half throttle, the blue throttle lamp blinks slowly. When the accelerator is depressed to about three quarters throttle the blue throttle lamp blinks rapidly. When the accelerator pedal moves from greater than to less than three quarters throttle, the blue throttle lamp once again blinks slowly, and as the accelerator pedal is released below about half throttle it once again lights steadily. If the throttle foot is lifted off the accelerator, and the brakes are not being applied, the blue throttle lamp extinguishes, and the amber idle lamp lights, indicating that the throttle foot is no longer on the accelerator. Additionally, the red brake lamp remains unlit until the driver's foot depresses the brake pedal, at which time the amber idle lamp extinguishes, and the red brake lamp illuminates.

Thus, no two lamps will be illuminated at any one time so long as the driver is using only a single foot on a single pedal at any one time. Should a driver use two feet to operate both the brake and accelerator at the same time, both the blue throttle lamp and the red brake lamp will light at the same time.

It will be apparent to persons skilled in the art that numerous enhancements and modifications can be made to the above described apparatus without departing from the basic inventive concepts. All such modifications and enhancements are considered to be within the scope of the present invention, the nature of which is to be determined from the foregoing description and the appended claims. Furthermore, the preceding Example is provided for illustrative purposes only, and is not intended to limit the scope of the invention.

I claim:

1. A throttle foot position indicator system for an automobile comprising a throttle lamp operably coupled to a throttle position sensor, an idle lamp operably coupled to the throttle position sensor and a brake position sensor, and a brake lamp operably coupled to the brake position sensor, wherein
the throttle lamp is illuminated when an accelerator pedal is depressed;
the idle lamp is illuminated when neither the accelerator pedal is depressed nor a brake pedal is depressed; and
the brake lamp is illuminated when the brake pedal is depressed.

2. The throttle foot position indicator system of claim 1, wherein the throttle lamp blinks when the accelerator pedal is depressed more than about halfway through its range of travel.

3. The throttle foot position indicator system of claim 2, wherein the throttle lamp blinks slowly when the accelerator pedal is depressed in a range from about halfway to about three quarters of the way through its range of travel, and blinks rapidly when the accelerator pedal is depressed further than about three quarters of the way through its range of travel.

4. The throttle foot position indicator system of claim 1, wherein the throttle lamp comprises a plurality of lamps, wherein a first throttle lamp illuminates when the accelerator pedal is depressed less than about halfway through its range of travel, a second throttle lamp illuminates when the accelerator pedal is depressed in a range from about halfway to about three quarters of the way through its range of travel, and a third throttle lamp illuminates when the accelerator pedal is depressed more than about three quarters of the way through its range of travel.

5. The throttle foot position indicator system of claim 4, wherein the idle lamp and the brake lamp each comprise a plurality of lamps.

6. The throttle foot position indicator system of claim 1, wherein the throttle lamp is blue, the idle lamp is amber, and the brake lamp is red.
